(19) United States
(12) Patent Application Publication
(10) Pub. No.: US 2016/0080604 A1
(43) Pub. Date: Mar. 17, 2016

(54) IMAGE FORMING DEVICE, NON-TRANSITORY COMPUTER READABLE MEDIUM, AND IMAGE FORMING METHOD

(71) Applicant: FUJI XEROX CO., LTD., Tokyo (JP)

(72) Inventor: Junya YAMADA, Kanagawa (JP)

(73) Assignee: FUJI XEROX CO., LTD., Tokyo (JP)

(21) Appl. No.: 14/638,248

(22) Filed: Mar. 4, 2015

(30) Foreign Application Priority Data
Sep. 12, 2014 (JP) 2014-186537

(51) Int. Cl. H04N 1/32; H04N 1/00

(52) U.S. Cl. CPC H04N 1/32545; H04N 1/00347; H04N 1/32496; H04N 1/00395; H04N 2201/007; H04N 2201/0096; H04N 2201/3205

(57) ABSTRACT

An image forming device includes a setting unit and an acquiring unit. Among a remaining connected image forming device group, the setting unit sets, for every time frame, an image forming device group excluding an image forming device set as an exclusion target as an image forming device group set as an access target. The acquiring unit accesses the image forming device group set as the access target. The acquiring unit accesses the image forming device group set as the access target corresponding to a time frame during the access so as to acquire image-data-related information stored in the image forming device group set as the access target.

### CROSS-REFERENCE TO RELATED APPLICATIONS

This application is based on and claims priority under 35 USC 119 from Japanese Patent Application No. 2014-186537 filed Sep. 12, 2014.

### BACKGROUND

### Technical Field

The present invention relates to image forming devices, non-transitory computer readable media, and image forming methods.

### SUMMARY

According to an aspect of the invention, there is provided an image forming device including a setting unit and an acquiring unit. Among a remaining connected image forming device group, the setting unit sets, for every time frame, an image forming device group excluding an image forming device set as an exclusion target as an image forming device group set as an access target. The acquiring unit accesses the image forming device group set as the access target. The acquiring unit accesses the image forming device group set as the access target corresponding to a time frame during the access so as to acquire image-data-related information stored in the image forming device group set as the access target.

### BRIEF DESCRIPTION OF THE DRAWINGS

Exemplary embodiments of the present invention will be described in detail based on the following figures, wherein:

FIG. 1 is a block diagram illustrating an image forming system according to an exemplary embodiment of the present invention;

FIG. 2 is a block diagram illustrating an image forming device;

FIG. 3 is a block diagram illustrating a terminal device;

FIG. 4 illustrates an example of a device list, an exclusion device list, and a reference device list;

FIG. 5 illustrates another example of the device list, the exclusion device list, and the reference device list;

FIG. 6 illustrates another example of the exclusion device list;

FIG. 7 is a flowchart illustrating an example of a process executed by the image forming device;

FIG. 8 illustrates an example of a screen of a display unit;

FIG. 9 illustrates an example of the screen of the display unit; and

FIG. 10 illustrates an example of the screen of the display unit.

### DETAILED DESCRIPTION

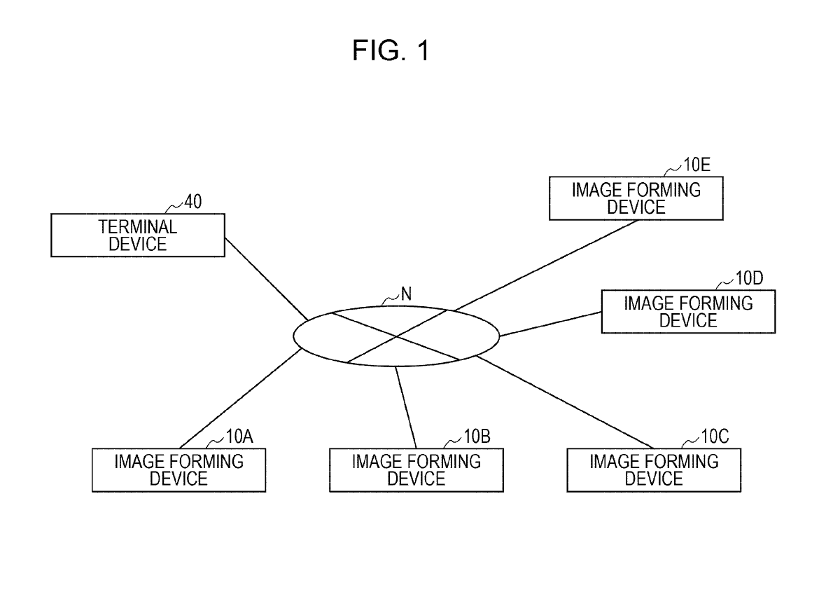

FIG. 1 illustrates an example of an image forming system according to an exemplary embodiment of the present invention. The image forming system includes multiple image forming devices (i.e., image forming devices 10A, 10B, 10C, 10D, and 10E as examples). If the image forming devices 10A, 10B, 10C, 10D, and 10E are not to be differentiated from one another, they will collectively be referred to as “image forming devices 10”. The multiple image forming devices 10 are connected to a communication path N, such as a network. Furthermore, a terminal device 40 is connected to the communication path N. Although five image forming devices 10 are included in the image forming system in the example shown in FIG. 1, this is only an example. The number of image forming devices 10 included in the image forming system may be a value other than five so long as multiple image forming devices 10 are included therein. Moreover, multiple terminal devices 40 may be connected to the communication path N.

The image forming devices 10 are, for example, electrophotographic printers. The terminal device 40 has a function for transmitting image data to each image forming device 10. Each image forming device 10 has a function for storing the image data transmitted from the terminal device 40.

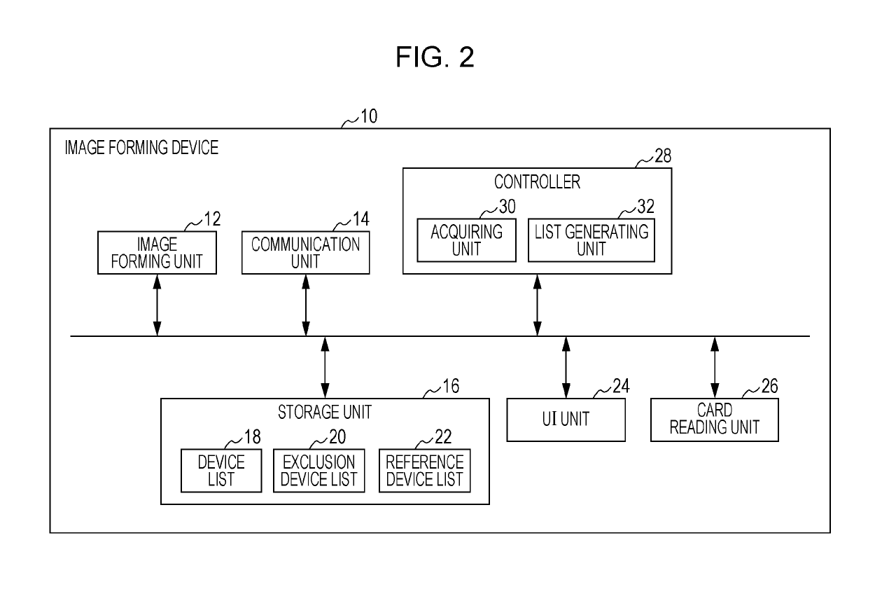

FIG. 2 illustrates the configuration of each image forming device 10. An image forming unit 12 forms an image onto a recording medium, such as paper, in accordance with image data. A communication unit 14 is a communication interface connected to the communication path N. The communication unit 14 has a function for receiving data from another device, as well as a function for transmitting data to another device.

A storage unit 16 is a storage device, such as a hard disk. The storage unit 16 stores therein a device list 18, an exclusion device list 20, and a reference device list 22. The device list 18 is information indicating all image forming devices 10 included in the image forming system. The device list 18 includes device identification information for identifying each image forming device 10. In the example shown in FIG. 1, the device identification information of each of the image forming devices 10A to 10E is included in the device list 18. The exclusion device list 20 is information indicating image forming device or devices 10 excluded from access targets among all image forming devices 10. The exclusion device list 20 includes device identification information for identifying each excluded image forming device 10. The reference device list 22 is information indicating image forming devices 10 set as access targets among all image forming devices 10. The reference device list 22 includes device identification information for identifying each image forming device 10 set as an access target. These lists will be described in detail later.

Furthermore, the storage unit 16 stores therein image data transmitted from the terminal device 40, as well as authentication information for user authentication. The image data is associated with user identification information (such as a user ID) for user identification. The authentication information includes, for example, user identification information and personal-identification-number information. The personal-identification-number information is information for confirming the identity of a user and is, for example, a password.

A user interface unit (UI unit) 24 includes an operable unit and a display unit. The operable unit is an input device, such as an operation panel. The display unit is a display device, such as a liquid crystal display. A card reading unit 26 has a function for reading information stored in an authentication card (e.g., an integrated-circuit (IC) card). For example, the user identification information and the personal-identification-number information included in the authentication information are stored in the authentication card. The authentication card is given to a user in advance for performing user authentication. Alternatively, the user identification information and the personal-identification-number information may be input by using the operable unit.

A controller 28 controls the operation of each unit of the image forming device 10. For example, when image data and user identification information are transmitted from the terminal device 40, the controller 28 stores the image data and the user identification information in association with each other into the storage unit 16.

The controller 28 includes an acquiring unit 30 and a list generating unit 32. The acquiring unit 30 refers to the reference device list 22 and accesses each image forming device 10 set as an access target. Then, the acquiring unit 30 acquires, from the image forming device 10 set as an access target, image identification information for identifying the image data. For example, when user identification information is input from the operable unit of the UI unit 24 or from the card reading unit 26, the acquiring unit 30 acquires, from the image forming device 10 set as an access target, the image identification information of the image data associated with that user identification information. The controller 28 causes the display unit of the UI unit 24 to display that image identification information. For example, the controller 28 causes the display unit to display the image identification information in the form of a list. When the user selects one piece of image identification information from that list, the acquiring unit 30 acquires the image data corresponding to the image identification information selected by the user from the image forming device 10 in which that image data is stored. Then, the image forming unit 12 forms an image onto paper in accordance with the acquired image data.

The list generating unit 32 generates the exclusion device list 20 and the reference device list 22. Specifically, the list generating unit 32 adds the device identification information of an image forming device 10 corresponding to an exclusion condition among all image forming devices 10 indicated in the device list 18 to the exclusion device list 20. The image forming device 10 registered in the exclusion device list 20 is registered as an exclusion device and is excluded from the access targets. The list generating unit 32 deletes, from the exclusion device list 20, the device identification information of an image forming device 10 that no longer corresponds to the exclusion condition. The image forming device 10 excluded from the exclusion device list 20 is excluded from the exclusion targets and becomes an access target. Furthermore, the list generating unit 32 adds, to the reference device list 22, the device identification information of an image forming device 10 not included in the exclusion device list 20 among all image forming devices 10 indicated in the device list 18. The image forming device 10 registered in the reference device list 22 becomes an access target. The list generating unit 32 updates the exclusion device list 20 and the reference device list 22 in accordance with the occurrence of an image forming device 10 that corresponds to the exclusion condition and the occurrence of an image forming device 10 that no longer corresponds to the exclusion condition.

Each image forming device 10 may alternatively be a printer that forms an image based on a method other than the electrophotographic method. Moreover, each image forming device 10 may have at least one of a copying function, a scanning function, and a facsimile function.

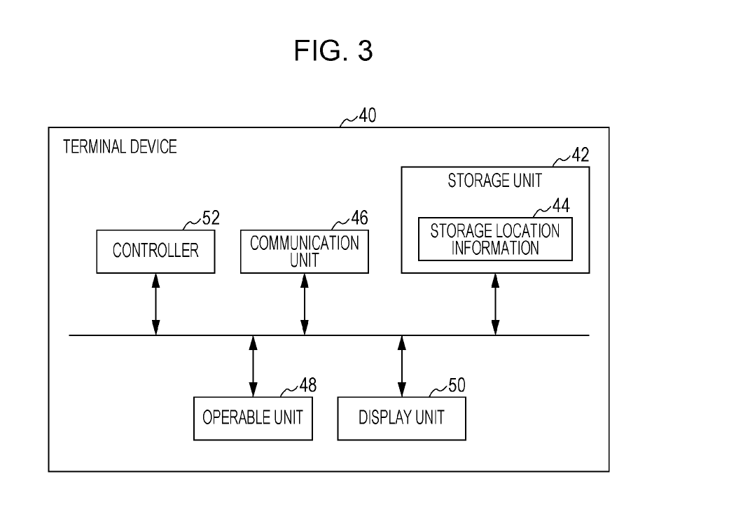

FIG. 3 illustrates the configuration of the terminal device 40. A storage unit 42 is a storage device, such as a hard disk. The storage unit 42 stores therein storage location information 44. Moreover, the storage unit 42 stores therein a printer driver. This printer driver is a program having a function for controlling each image forming device 10. The storage location information 44 is information that indicates an image forming device 10 that is to store image data transmitted from the terminal device 40. In the example of the image forming system shown in FIG. 1, the storage location information 44 is information that indicates any one of the image forming devices 10A, 10B, 10C, 10D, and 10E. The storage location information 44 is, for example, the device identification information of the corresponding image forming device 10. As an alternative example, the storage location information 44 may be an Internet Protocol (IP) address allocated to the corresponding image forming device 10. As an example, the storage location information 44 is the device identification information of the image forming device 10C. The storage location information 44 may be changed by a user.

A communication unit 46 is a communication interface connected to the communication path N. The communication unit 46 has a function for receiving data from another device, as well as a function for transmitting data to another device. For example, the communication unit 46 has a function for transmitting image data designated by a user and user identification information of the user to the image forming device 10 indicated by the storage location information 44.

An operable unit 48 is an input device, such as a keyboard and/or a mouse. A display unit 50 is a display device, such as a liquid crystal display. A controller 52 controls the operation of each unit of the terminal device 40.

### Outline of Process in Image Forming System

The outline of a process performed by the image forming system will now be described. First, a user uses the operable unit 48 of the terminal device 40 to designate image data to be formed and commands image formation (such as printing). Under the control of the controller 52, the communication unit 46 transmits the image data designated by the user and the user identification information to the image forming device 10 indicated by the storage location information 44. Because the storage location information 44 indicates the image forming device 10C as an example, the image data and the user identification information are transmitted to the image forming device 10C.

The communication unit 14 of the image forming device 10C receives the image data and the user identification information transmitted from the terminal device 40. Then, the controller 28 stores the received image data and the received user identification information in association with each other into the storage unit 16.

After commanding image formation, the user moves to any one of the image forming devices 10A, 10B, 10C, 10D, and 10E. For example, the user may move to the image forming device 10 that he/she usually uses or to another image forming device 10 if the former image forming device 10 is being used. Alternatively, the user may move to the nearest image forming device 10 from his/her location. In this case, it is assumed that the user moves to the image forming device 10E shown in FIG. 1.

When the user inputs the user identification information and the personal-identification-number information to the image forming device 10E, the acquiring unit 30 of the image forming device 10E refers to the reference device list 22 and accesses an image forming device 10 set as an access target. Then, the acquiring unit 30 acquires, from the image forming device 10 set as an access target, image identification information of the image data associated with the user identification information. For example, if the image forming device 10C is registered in the reference device list 22, the acquiring unit 30 of the image forming device 10E accesses the image forming device 10C and acquires the image identification information of the image data from the image forming device 10C. The controller 28 of the image forming device 10E causes the display unit of the UI unit 24 to display a list of the image identification information acquired by the acquiring unit 30. When the user selects one item of image data from that list, the acquiring unit 30 acquires the selected image data from an image forming device 10 in which the selected image data is stored. For example, if the image data stored in the image forming device 10C is selected, the acquiring unit 30 acquires the selected image data from the image forming device 10C. The image forming unit 12 forms an image onto paper in accordance with the acquired image data.

Accordingly, each image forming device 10 has a function for acquiring image data stored in another image forming device 10 and for forming an image in accordance with the acquired image data. Thus, a user does not have to store image data in an image forming device 10 in which image formation is to be actually executed. Image formation may be executed in any one of the multiple image forming devices 10 included in the image forming system by storing the image data in any one of the image forming devices 10.

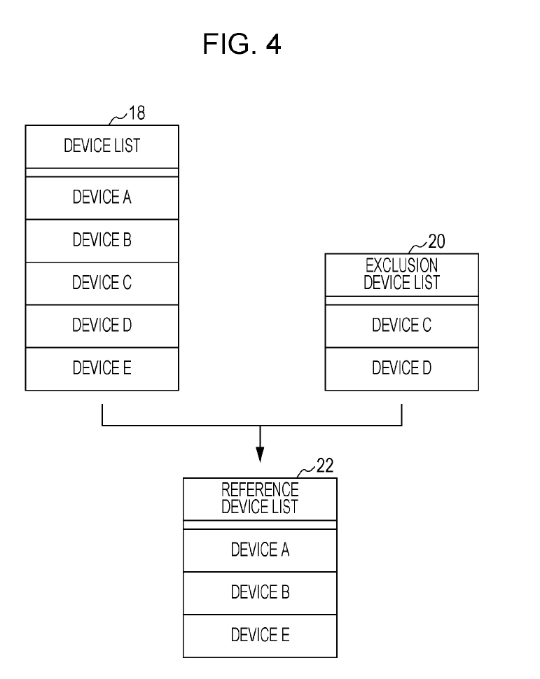

Next, a specific example of the device list 18, the exclusion device list 20, and the reference device list 22 will be described with reference to FIG. 4. These lists are stored in the storage unit 16 of each image forming device 10.

The device list 18 includes the device identification information of all image forming devices 10 included in the image forming system. For example, “device A” indicates the device identification information of the image forming device 10A, “device B” indicates the device identification information of the image forming device 10B, “device C” indicates the device identification information of the image forming device 10C, “device D” indicates the device identification information of the image forming device 10D, and “device E” indicates the device identification information of the image forming device 10E. The device list 18 is generated by, for example, an administrator. When a new image forming device 10 is connected to the communication path N, the controller 28 of each image forming device 10 may detect the newly-connected image forming device 10. In this case, the list generating unit 32 adds the device identification information of the newly-connected image forming device 10 to the device list 18.

The exclusion device list 20 includes the device identification information of each image forming device 10 excluded from the access targets. For example, the exclusion device list 20 includes the devices C and D among the devices A to E. Specifically, this exclusion device list 20 indicates that the image forming devices 10C and 10D are the devices excluded from the access targets. According to this exclusion device list 20, the acquiring unit 30 does not access the image forming devices 10C and 10D.

The reference device list 22 includes the device identification information of each image forming device 10 set as an access target. For example, the reference device list 22 includes the devices A, B, and C but does not include the excluded devices C and D among the devices A to E. Specifically, this reference device list 22 indicates that the image forming devices 10A, 10B, and 10E are the devices set as the access targets. According to this reference device list 22, the acquiring unit 30 accesses the image forming devices 10A, 10B, and 10E.

Next, a specific example of a generation condition, that is, the exclusion condition, of the exclusion device list 20 will be described.

### First Exemplary Embodiment

### Exclusion by User

In a first exemplary embodiment, a user designates an image forming device 10 to be excluded from the access targets. As a specific example, an image forming device 10 under repair, an image forming device 10 in a power-off state, or an image forming device 10 temporarily disconnected from the communication path N is excluded from the access targets. Even when such an image forming device 10 is accessed, image identification information and image data are not acquirable from the image forming device 10. Therefore, such an image forming device 10 is excluded from the access targets. For example, the user uses the operable unit of the UI unit 24 to input the device identification information of an image forming device 10 to be excluded from the access targets. Alternatively, the user may use the terminal device 40 to input the device identification information. The list generating unit 32 adds the device identification information of the image forming device 10 designated by the user to the exclusion device list 20 and also deletes the device identification information from the reference device list 22. Thus, the exclusion device list 20 and the reference device list 22 are updated. In the example shown in FIG. 4, the image forming devices 10C and 10D are excluded from the access targets by the user.

Furthermore, the user may designate an image forming device 10 that no longer corresponds to the exclusion condition. With reference to the above specific example, the image forming device 10 for which the repair has been completed, the image forming device 10 set to a power-on state, or the image forming device 10 connected to the communication path N is designated as a device that no longer corresponds to the exclusion condition. For example, the user uses the operable unit of the UI unit 24 or the terminal device 40 to input the device identification information of an image forming device 10 to be set as an access target. The list generating unit 32 deletes the device identification information of the image forming device 10 designated by the user from the exclusion device list 20 and also adds the device identification information to the reference device list 22. Thus, the exclusion device list 20 and the reference device list 22 are updated.

According to the first exemplary embodiment, an image forming device 10 that is not capable of transmitting image identification information is not accessed. Thus, wasteful access may be prevented, so that the total time taken for acquiring image identification information may be shortened, as compared with a case where the image forming devices 10A to 10E are all accessed.

### Second Exemplary Embodiment

### Exclusion Based on Communication Timeout

In a second exemplary embodiment, when the acquiring unit 30 accesses another image forming device 10, if communication timeout occurs, the image forming device 10 in which the timeout has occurred is excluded from the access targets. In other words, an image forming device 10 not successfully accessed is excluded from the access targets. Even when such an image forming device 10 is accessed, image identification information and image data are not acquirable from the image forming device 10. Therefore, such an image forming device 10 is excluded from the access targets.

For example, in a case where the acquiring unit 30 transmits a request for data to another image forming device 10, if a response is not received from the image forming device 10 after a predetermined time period, the image forming device 10 is excluded from the access targets. With regard to the image forming device 10 in which the timeout has occurred, it is assumed that, for example, the image forming device 10 is in a power-off state, is in a communication failure state, or is temporarily disconnected from the communication path N. In this case, the list generating unit 32 adds the device identification information of the image forming device 10 in which the timeout has occurred to the exclusion device list 20, and also deletes the device identification information from the reference device list 22. Thus, the exclusion device list 20 and the reference device list 22 are updated. In the example shown in FIG. 4, the image forming devices 10C and 10D are the devices in which timeout has occurred.

According to the second exemplary embodiment, the image forming device 10 not successfully accessed is not accessed thereafter. Thus, wasteful access may be prevented, so that the total time taken for acquiring image identification information may be shortened, as compared with a case where the image forming devices 10A to 10E are all accessed.

Furthermore, under the control of the controller 28, the communication unit 14 may access an image forming device 10, which has been excluded from the access targets due to the occurrence of timeout, at predetermined time intervals. If the access is successful, the list generating unit 32 deletes the device identification information of the successfully-accessed image forming device 10 from the exclusion device list 20 and also adds the device identification information to the reference device list 22. Thus, the exclusion device list 20 and the reference device list 22 are automatically updated. If the access is unsuccessful, the exclusion device list 20 and the reference device list 22 are not updated. For example, the communication unit 14 transmits a predetermined request to an image forming device 10 that has been excluded from the access targets due to the occurrence of timeout. Then, if a response is received from the image forming device 10 within a predetermined time period, the image forming device 10 is excluded from the exclusion targets. With regard to the image forming device 10 that has transmitted the response, it is assumed that, for example, the image forming device 10 is set to a power-on state, has recovered from a communication failure state, or is connected to the communication path N. In this case, the list generating unit 32 deletes the device identification information of the image forming device 10 having transmitted the response from the exclusion device list 20 and also adds the device identification information to the reference device list 22. This process may be executed on an image forming device 10 excluded from the access targets by the user. Specifically, the communication unit 14 accesses the image forming device 10, which has been excluded from the access targets by the user, at predetermined time intervals. The list generating unit 32 deletes the device identification information of the successfully-accessed image forming device 10 from the exclusion device list 20 and also adds the device identification information to the reference device list 22.

Furthermore, when a predetermined time period elapses after device identification information is added to the exclusion device list 20, the list generating unit 32 may delete the device identification information from the exclusion device list 20 and may also add the device identification information to the reference device list 22. Thus, the exclusion device list 20 and the reference device list 22 are automatically updated. An image forming device 10 on which this process is to be performed may be an image forming device 10 excluded due to the occurrence of timeout or an image forming device 10 excluded by the user.

The communication unit 14 may transmit, to another image forming device 10, confirmation information for confirming the connection at predetermined time intervals. If there is no response from this image forming device 10, the list generating unit 32 adds the device identification information of the image forming device 10 to the exclusion device list 20 and deletes the device identification information from the reference device list 22. Alternatively, the communication unit 14 may repeatedly transmit the confirmation information for a predetermined number of times. If there is still no response, the list generating unit 32 may add the device identification information of the non-responding image forming device 10 to the exclusion device list 20.

### Third Exemplary Embodiment

### Exclusion Based on Time Frame

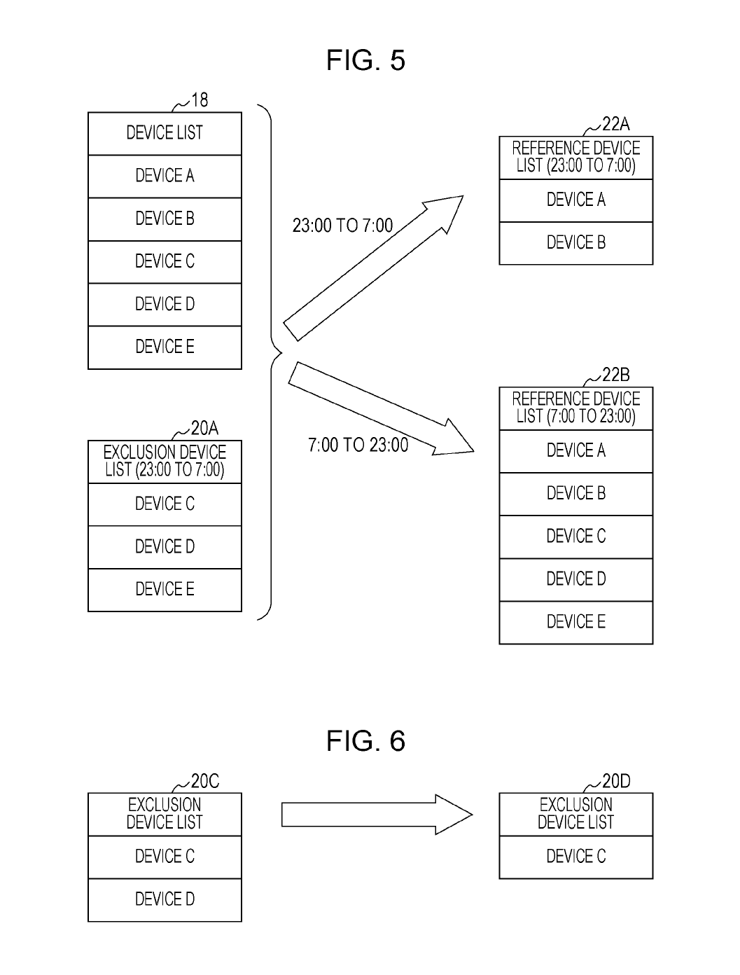

In a third exemplary embodiment, an image forming device 10 as an exclusion target is set for every predetermined time frame. The third exemplary embodiment will be described below with reference to FIG. 5. An exclusion device list 20A includes the device identification information of each image forming device 10 excluded from the access targets in a predetermined time frame. In the example shown in FIG. 5, the exclusion device list 20A includes the devices C, D, and E. Moreover, an exclusion time frame is set between 23:00 and 7:00. In other words, in the time frame between 23:00 and 7:00, the acquiring unit 30 does not access the image forming devices 10C, 10D, and 10E. In this case, the list generating unit 32 generates a reference device list 22A for the time frame between 23:00 and 7:00 (i.e., a first time frame) and a reference device list 22B for a time frame between 7:00 and 23:00 (i.e., a second time frame). The reference device list 22A includes the devices A and B, which are device identification information other than the devices C, D, and E. The reference device list 22B includes the device identification information of all devices (i.e., the devices A to E).

In the time frame between 23:00 and 7:00, the acquiring unit 30 accesses the image forming devices 10A and 10B in accordance with the reference device list 22A. On the other hand, in the time frame between 7:00 and 23:00, the acquiring unit 30 accesses the image forming devices 10A to 10E in accordance with the reference device list 22B.

For example, there is a case where a time frame in which an image forming device 10 is turned off or a time frame in which an image forming device 10 is temporarily disconnected from the communication path N is set in advance. In this case, the time frame is set as a non-access time frame. With reference to a specific example, in a case where the power of image forming devices 10 is managed for each floor of an office, a time frame in which image forming devices 10 are turned off may be set in advance for each floor. In this case, the time frame corresponding to the power-off state is set as the non-access time frame.

According to the third exemplary embodiment, in a time frame in which an image forming device 10 is turned off or in a time frame in which an image forming device 10 is temporarily disconnected from the communication path N, the image forming device 10 is not accessed. Thus, wasteful access may be prevented, so that the total time taken for acquiring image identification information may be shortened, as compared with a case where the image forming devices 10A to 10E are all accessed.

The controller 28 of each image forming device 10 may manage the power history of each image forming device 10. For example, the controller 28 refers to the power history and accesses an image forming device 10 that has been turned on in the past even during the exclusion time frame. If that image forming device 10 is actually in a power-on state and is successfully accessed, the list generating unit 32 deletes the device identification information of that image forming device 10 from the exclusion device list 20. Specifically, when image identification information is to be acquired, the acquiring unit 30 accesses the image forming device 10 that has been turned on in the past even during the exclusion time frame. If the access is successful, the acquiring unit 30 acquires image identification information from that image forming device 10. Alternatively, under the control of the controller 28, the communication unit 14 may transmit confirmation information for confirming the connection to the image forming device 10 that has been turned on in the past even during the exclusion time frame. If there is a response to the transmitted confirmation information, the list generating unit 32 deletes the device identification information of that image forming device 10 from the exclusion device list 20.

### Fourth Exemplary Embodiment

### Exclusion Based on Power

In a fourth exemplary embodiment, when each image forming device 10 is to be turned off, the image forming device 10 transmits power-off information indicating a power-off state to another image forming device 10. In the image forming device 10 having received the power-off information, the list generating unit 32 adds the device identification information of the image forming device 10 set to the power-off state to the exclusion device list 20 and deletes the device identification information from the reference device list 22. Thus, the image forming device 10 set to the power-off state is automatically registered in the exclusion device list 20.

Furthermore, when each image forming device 10 is turned on, the image forming device 10 may transmit power-on information indicating the power-on state to another image forming device 10. In the image forming device 10 having received the power-on information, if the device identification information of the image forming device 10 set to the power-on state is included in the exclusion device list 20, the list generating unit 32 deletes the device identification information of that image forming device 10 from the exclusion device list 20 and adds the device identification information to the reference device list 22. Thus, the image forming device 10 set to the power-on state is automatically deleted from the exclusion device list 20.

The first to fourth exemplary embodiments described above may be mutually combined.

FIG. 6 illustrates an example in which the exclusion device list is updated. For example, an exclusion device list 20C includes the devices C and D. In this case, when the exclusion of the device D is cancelled, the device D is deleted from the exclusion device list 20C, whereby a new exclusion device list 20D is generated. This exclusion device list 20D includes the device C alone. As in the first to fourth exemplary embodiments described above, the exclusion may be cancelled by a user, the exclusion may be cancelled when access is successful, or the exclusion may be cancelled when an image forming device 10 is turned on.

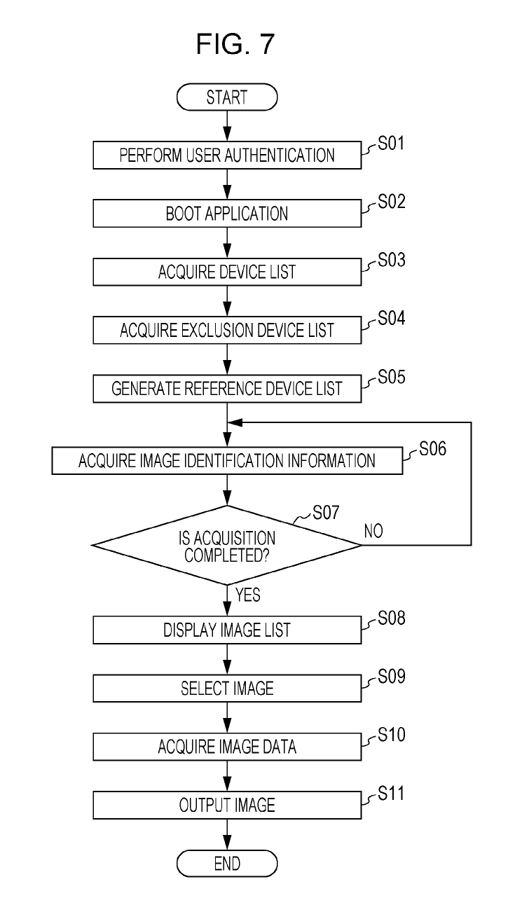

Next, a process executed in each image forming device 10 will be described with reference to FIG. 7. In this case, it is assumed that image data has already been transmitted from the terminal device 40 to the image forming device 10, and that the image data is stored in the image forming device 10.

For example, it is assumed that the user identification information of a user who has transmitted the image data is “user001”. Furthermore, it is assumed that image data D1 and image data D2 associated with the user identification information “user001” are stored in the image forming device or devices 10. For example, it is assumed that the image data D1 is stored in the image forming device 10A, and the image data D2 is stored in the image forming device 10B. Needless to say, the image data D1 and the image data D2 associated with the user identification information “user001” may be stored in other image forming devices 10. Moreover, the image data D1 and the image data D2 may be stored in a single image forming device 10.

In this case, it is assumed that the user uses the image forming device 10E to print the image data. First, user authentication is executed in step S01. In order to achieve this, the user uses the operable unit of the UI unit 24 or the card reading unit 26 to input the user identification information and personal-identification-number information into the image forming device 10E. When these pieces of information are input, the controller 28 in the image forming device 10E compares the input user identification information and the input personal-identification-number information with user identification information and personal-identification-number information included in authentication information stored in the storage unit 16. If these pieces of information match, the authentication is successful. In contrast, if these pieces of information do not match, the authentication is unsuccessful. When the authentication is unsuccessful, the process ends. When the authentication is successful, the process proceeds to step S02. The authentication process may be executed by an authentication server. In this case, the authentication information is stored in the authentication server. When the user identification information and the personal-identification-number information are input to the image forming device 10E, these pieces of information are transmitted to the authentication server. The authentication server performs the authentication process and transmits the authentication result to the image forming device 10E.

After the authentication succeeds, the user boots a target application in step S02. In this case, an application for printing image data stored in the image forming devices 10A to 10E is booted.

In step S03, the list generating unit 32 of the image forming device 10E acquires the device list 18 stored in the storage unit 16. Furthermore, in step S04, the list generating unit 32 acquires the exclusion device list 20 stored in the storage unit 16. Then, in step S05, the list generating unit 32 excludes device identification information indicated in the exclusion device list 20 from multiple pieces of device identification information indicated in the device list 18, thereby generating a reference device list 22 indicating image forming devices 10 set as access targets. With reference to the example shown in FIG. 4, the reference device list 22 including the devices A, B, and E is generated. With reference to the example shown in FIG. 5, if the current time frame is between 23:00 and 7:00, the reference device list 22A including the devices A and B is generated, or if the current time frame is between 7:00 and 23:00, the reference device list 22B including the devices A to E is generated. In this case, it is assumed that a reference device list 22 including the devices A, B, and E (i.e., the list shown in FIG. 4) is generated. Alternatively, the reference device list 22 may be generated in advance. In this case, steps S03 to S05 are omitted.

Subsequently, in step S06, the acquiring unit 30 of the image forming device 10E accesses the image forming devices 10 in accordance with the reference device list 22 and acquires image identification information therefrom. Alternatively, the process in the acquiring unit 30 may be executed after the user uses the operable unit of the UI unit 24 to give an acquisition command. Since the reference device list 22 includes the devices A, B, and E, the acquiring unit 30 accesses the image forming devices 10A and 10B. If the image data associated with the user identification information “user001” is stored in the image forming devices 10A and 10B, the acquiring unit 30 acquires the image identification information of the image data. Moreover, the acquiring unit 30 accesses the storage unit 16 of the image forming device 10E. If the image data associated with the user identification information “user001” is stored in the storage unit 16, the acquiring unit 30 acquires the image identification information of that image data. As described above, the image data D1 is stored in the image forming device 10A, and the image data D2 is stored in the image forming device 10B. Therefore, the acquiring unit 30 acquires the image identification information of the image data D1 from the image forming device 10A and the image identification information of the image data D2 from the image forming device 10B. Then, step S06 continues until the image identification information of the image data associated with the user identification information “user001” is acquired from all image forming devices 10 indicated in the reference device list 22 (i.e., the image forming devices 10A, 10B, and 10E) (No in step S07).

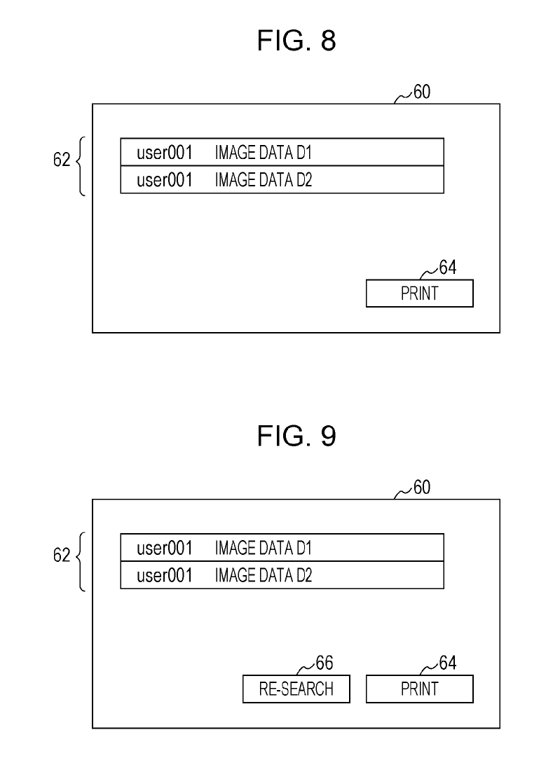

When the image identification information is completely acquired (Yes in step S07), the controller 28 of the image forming device 10E causes the display unit of the UI unit 24 to display the image identification information of the image data D1 and the image identification information of the image data D2. For example, these pieces of information are displayed in the form of a list. FIG. 8 illustrates a display example. A screen 60 of the display unit displays a list 62 of the image identification information of the image data D1 and the image identification information of the image data D2. Moreover, the user identification information “user001” is also displayed.

In step S09, the user selects image data to be printed from the list 62. For example, the image data D1 is selected. In this case, the acquiring unit 30 of the image forming device 10E accesses the image forming device 10A and acquires the image data D1 from the image forming device 10A in step S10. In step S11, when the user commands printing, the image forming unit 12 of the image forming device 10E forms an image onto paper in accordance with the image data D1. For example, a print command is input by pressing a print button 64 shown in FIG. 8. Alternatively, at the point when the print button 64 is pressed, the acquiring unit 30 may acquire the image data D1, and the image forming unit 12 may subsequently form an image onto paper in accordance with the image data D1.

According to the above exemplary embodiments, the image forming devices 10C and 10D indicated in the exclusion device list 20 are not accessed. For example, an image forming device 10 in a power-off state or an image forming device 10 in which communication timeout has occurred are not accessed. In other words, an image forming device 10 that is not capable of transmitting image identification information or image data is not accessed. Thus, wasteful access may be prevented. Consequently, the total time taken for acquiring image identification information may be shortened, as compared with a case where the image forming devices 10A to 10E are all accessed. With reference to the example shown in FIG. 4, since only the image forming devices 10A, 10B, and 10E are accessed, the total time taken for acquiring image identification information may be shortened, as compared with a case where the image forming devices 10A to 10E are all accessed. As a result, the time taken from booting of an application to displaying of a list of image identification information, that is, the waiting time until the list is displayed, may be shortened, as compared with a case where the image forming devices 10A to 10E are all accessed.

### Modification

Next, a modification will be described. In this modification, after the acquiring unit 30 acquires image identification information, a re-search (re-acquisition) is executed. For example, when a user commands a re-search by using the operable unit of the UI unit 24, the acquiring unit 30 accesses the excluded image forming device or devices 10 indicated in the exclusion device list 20. If the access is successful, the acquiring unit 30 acquires image identification information from the successfully-accessed image forming device or devices 10 set as exclusion target or targets.

For example, among image forming devices 10 included in the exclusion device list 20, there may be a device that has been turned on or a device in which communication timeout has been resolved. Naturally, such an image forming device 10 (i.e., a recovered image forming device 10) should be excluded from the exclusion device list 20. However, even when the power has been turned on or communication timeout has been resolved, the device identification information of the recovered image forming device 10 is not deleted from the exclusion device list 20 unless the exclusion device list 20 is updated. In other words, depending on the timing at which the exclusion device list 20 is updated, the recovered image forming device 10 remains registered in the exclusion device list 20. Therefore, the recovered image forming device 10 does not become included in the reference device list 22 and thus does not become an access target for the acquiring unit 30. As a countermeasure against this situation, in this modification, when the user commands a re-search, the acquiring unit 30 accesses the image forming device or devices 10 indicated in the exclusion device list 20. Thus, image identification information is acquired from the recovered image forming device or devices 10 included in the reference device list 22.

Alternatively, the acquiring unit 30 may access all image forming devices 10 indicated in the device list 18. Even in this case, the acquiring unit 30 accesses the image forming device or devices 10 indicated in the exclusion device list 20. Thus, image identification information is acquired from the recovered image forming device or devices 10 included in the reference device list 22.

This modification will now be described with reference to a specific example. For example, it is assumed that the user identification information of a user who has transmitted image data is “user001”. Furthermore, it is assumed that image data D1, image data D2, image data D3, and image data D4 associated with the user identification information “user001” are stored in the image forming device or devices 10. For example, it is assumed that the image data D1 is stored in the image forming device 10A, the image data D2 is stored in the image forming device 10B, the image data D3 is stored in the image forming device 10C, and the image data D4 is stored in the image forming device 10D. Furthermore, as shown in FIG. 4, it is assumed that the original exclusion device list 20 includes the devices C and D, and the original reference device list 22 includes the devices A, B, and E. For example, it is assumed that, due to the image forming devices 10C and 10D being in a power-off state, the image forming devices 10C and 10D are included in the exclusion device list 20.

In this case, it is assumed that the user uses the image forming device 10E to print the image data. When the process is executed in accordance with the flowchart shown in FIG. 7, the acquiring unit 30 of the image forming device 10E acquires image identification information, and the acquired image identification information is displayed on the display unit of the UI unit 24 in the image forming device 10E. Since the reference device list 22 includes the devices A, B, and E, the image identification information acquired from each of the image forming devices 10A, 10B, and 10E is displayed on the display unit. In this case, the image identification information of the image data D1 is acquired from the image forming device 10A, and the image identification information of the image data D2 is acquired from the image forming device 10B. Since the exclusion device list 20 includes the devices C and D, the acquiring unit 30 of the image forming device 10E does not access the image forming devices 10C and 10D. Therefore, the image identification information of the image data D3 and the image identification information of the image data D4 are not acquired.

FIG. 9 illustrates a display example of image identification information. The screen 60 of the display unit displays the list 62 of the image identification information of the image data D1 and the image identification information of the image data D2. Because the image forming devices 10C and 10D are not set as access targets, the image identification information of the image data D3 and the image identification information of the image data D4 are not displayed. In this modification, a re-search button 66 for commanding a re-search (re-acquisition) is provided within the screen 60. When the user presses the re-search button 66, the acquiring unit 30 executes a re-search. For example, it is assumed that a re-search is commanded when image identification information of image data saved by the user is not displayed on the screen of the UI unit 24.

For example, it is assumed that the exclusion device list 20 is not updated after the image forming devices 10C and 10D are turned on. An example of such a situation includes a case where the image forming devices 10C and 10D are turned on immediately before the user uses the image forming device 10E or immediately before the acquiring unit 30 of the image forming device 10E executes an acquisition process. In such a case, the acquisition process by the acquiring unit 30 may sometimes start before the exclusion device list 20 is updated. As a result, the acquiring unit 30 does not access the image forming devices 10C and 10D regardless of the fact that the image forming devices 10C and 10D are turned on. This modification deals with such a situation.

When a re-search is commanded by the user, the acquiring unit 30 accesses the image forming devices 10C and 10D indicated in the exclusion device list 20. Then, if the access is successful, the acquiring unit 30 acquires the image identification information of the image data D3 from the image forming device 10C and the image identification information of the image data D4 from the image forming device 10D.

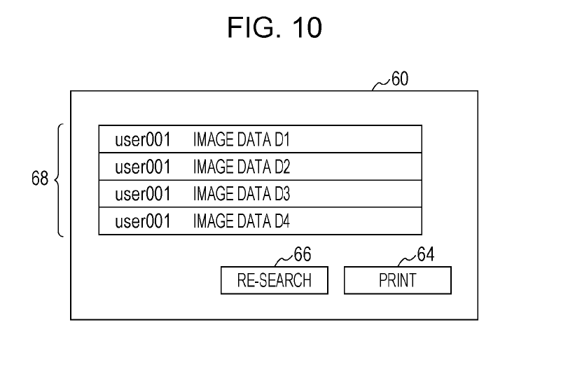

Then, the controller 28 updates an image-identification-information list. FIG. 10 illustrates a display example after the update. An image-identification-information list 68 includes the image identification information of each of the image data D1 to the image data D4. The image identification information of each of the image data D1 and the image data D2 is information acquired as a result of the previous acquisition process. The image identification information of each of the image data D3 and the image data D4 is information acquired as a result of the re-search (re-acquisition) process.

According to this modification, a recovered image forming device 10 not excluded from the exclusion device list 20 is accessed. If the access is successful, image identification information is acquired from that image forming device 10. Thus, the image identification information is acquired from the recovered image forming device 10 continuously registered in the exclusion device list 20.

Furthermore, the list generating unit 32 deletes the device identification information of an image forming device 10 successfully accessed by the re-search process from the exclusion device list 20 and adds the device identification information to the reference device list 22. Thus, the exclusion device list 20 and the reference device list 22 are updated, and the acquiring unit 30 accesses that image forming device 10 thereafter.

On the other hand, image identification information of an image forming device 10 not successfully accessed even by performing a re-search remains in the exclusion device list 20.

In each exemplary embodiment and the modification described above, the acquiring unit 30 acquires image identification information from another image forming device 10 in advance and subsequently acquires user-selected image data from that image forming device 10. As another example, the acquiring unit 30 may acquire image data from another image forming device 10 without acquiring image identification information therefrom in advance. In this case, the controller 28 causes the display unit of the UI unit 24 to display the image identification information of the acquired image data. When the user selects the image data, the image forming unit 12 forms an image onto paper in accordance with the selected image data. The data volume of the image data itself is normally greater than the data volume of the image identification information. Therefore, the total time taken for data transmission may be shortened by acquiring the image data based on user selection after temporarily acquiring the image identification information, rather than by acquiring the image data itself regardless of whether or not selection is made by the user.

Each of the aforementioned image forming devices 10 is implemented by, for example, cooperation between a hardware resource and software. Specifically, each image forming device 10 includes a processor, such as a central processing unit (CPU) (not shown). The processor reads and executes a program stored in a storage device (not shown) so as to implement the function of each unit in the image forming device 10. The program is stored into the storage device via a storage medium, such as a compact disc (CD) or a digital versatile disc (DVD), or via a communication path, such as a network. Alternatively, each unit of the image forming device 10 may be implemented by, for example, a hardware resource, such as a processor or an electronic circuit. For this implementation, a device, such as a memory device, may be used.

Furthermore, the aforementioned terminal device 40 is implemented by, for example, cooperation between a hardware resource and software. Specifically, the terminal device 40 includes a processor, such as a CPU (not shown). The processor reads and executes a program stored in a storage device (not shown) so as to implement the function of each unit in the terminal device 40. The program is stored into the storage device via a storage medium, such as CD or a DVD, or via a communication path, such as a network. Alternatively, each unit of the terminal device 40 may be implemented by, for example, a hardware resource, such as a processor or an electronic circuit. For this implementation, a device, such as a memory device, may be used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming device comprising:
a setting unit, wherein among a remaining connected image forming device group, the setting unit sets, for every time frame, an image forming device group excluding an image forming device set as an exclusion target as an image forming device group set as an access target; and
an acquiring unit that accesses the image forming device group set as the access target, wherein the acquiring unit accesses the image forming device group set as the access target corresponding to a time frame during the access so as to acquire image-data-related information stored in the image forming device group set as the access target.

2. The image forming device according to claim 1,
wherein, among the image forming device group set as the access target, the setting unit registers an image forming device not successfully accessed by the acquiring unit as the image forming device set as the exclusion target.

3. The image forming device according to claim 2, further comprising:
an accessing unit that accesses, at a predetermined time interval, another image forming device that is not successfully accessed,
wherein the setting unit excludes another image forming device, which is successfully accessed by the accessing unit, from the exclusion target.

4. The image forming device according to claim 2,
wherein the setting unit excludes another image forming device, which is not successfully accessed, from the exclusion target when a predetermined time period elapses.

5. The image forming device according to claim 1,
wherein when a command for re-acquiring the image-data-related information is received, the acquiring unit accesses the image forming device set as the exclusion target so as to acquire the image-data-related information.

6. The image forming device according to claim 1,
wherein when a command for re-acquiring the image-data-related information is received, the acquiring unit accesses the remaining connected image forming device group so as to acquire the image-data-related information.

7. The image forming device according to claim 1,
wherein the setting unit registers another image forming device set to a power-off state as the image forming device set as the exclusion target.

8. The image forming device according to claim 1,
wherein the setting unit excludes another image forming device set to a power-on state from the exclusion target.

9. A non-transitory computer readable medium storing a program causing a computer to execute an image forming process, the image forming process comprising:
setting, for every time frame, an image forming device group excluding an image forming device set as an exclusion target as an image forming device group set as an access target, the image forming device group set as the access target and the image forming device set as the exclusion target being included in a remaining connected image forming device group; and
accessing the image forming device group set as the access target corresponding to a time frame during the accessing so as to acquire image-data-related information stored in the image forming device group set as the access target.

10. An image forming method comprising:
setting, for every time frame, an image forming device group excluding an image forming device set as an exclusion target as an image forming device group set as an access target, the image forming device group set as the access target and the image forming device set as the exclusion target being included in a remaining connected image forming device group; and
accessing the image forming device group set as the access target corresponding to a time frame during the accessing so as to acquire image-data-related information stored in the image forming device group set as the access target.
